(19) United States
(12) Patent Application Publication
(10) Pub. No.: US 2001/0041156 A1
(43) Pub. Date: Nov. 15, 2001

(54) Reactor for a coling installation

(76) Inventor: Norbert Patzner, Bad Mergentheim (DE)

Correspondence Address: FASSE PATENT ATTORNEYS, P.A., P.O. BOX 726, HAMPDEN, ME, 04444-0726, US

(21) Appl. No.: 09/823,913

(22) Filed: Mar. 30, 2001

(30) Foreign Application Priority Data
Mar. 30, 2000 (DE) 100 15 886.2

(51) Int. Cl. B01J 8/04; B01J 8/02

(52) U.S. Cl. 422/190; 422/198; 422/211

(57) ABSTRACT

The invention relates to a reactor for a cooling installation for performing an adsorption and desorption process functioning in particular with zeolite as adsorbent and with water as adsorbate, the inside of a vacuum-tight housing being connectable to a vacuum generator and to a vessel containing water, and having a heating device and a sealable outlet opening for water vapor.

The essence of the invention resides in the fact that at least one inner vessel containing the zeolite is provided and that it has a vessel wall, which is permeable to air and water vapor, and that at least one heating device is arranged inside the inner vessel

### DESCRIPTION

The invention relates to a reactor for a cooling installation for performing an adsorption and desorption process and having the features of the preamble of claim 1, the pair of substances involved preferably consisting of zeolite and water. The zeolite, by reason of its hygroscopic characteristics, adsorbs water vapor with great briskness, so that fresh water vapor must be produced in order to re-establish the physical equilibrium. As a result of the vaporization heat drawn from the surroundings the water cools and forms ice. During this process the zeolite (the adsorbent) becomes charged with water (the adsorbate) until a saturation limit is reached. The saturation limit is reached when the adsorption capacity of the zeolite is exhausted. In order to restore this, heat energy must be supplied to the zeolite in excess of a certain temperature range. Thus, heating the zeolite to a temperature of approx. 200 to 250° C. leads to expulsion of the water vapor. The generally granulated or globular zeolite is then hygroscopic again and once more ready to absorb water vapor, until such time as a new state of physical equilibrium is established.

It is essential for proper efficiency of the cooling installation that the zeolite can rapidly absorb the water vapor forming in the evaporator and also that it rapidly releases this again. The water vapor absorption is assisted by the strongest possible negative pressure (vacuum) in the housing containing the zeolite as packing or filling before commencement of the adsorption process.

The object of the invention is to provide measures, by means of which the greatest possible amount of heat per unit time can be transmitted to the zeolite during the desorption phase, so that it likewise gives off (desorbs) the adsorbed water as rapidly as possible.

To achieve this object the invention proposes that at least one inner vessel containing the zeolite be arranged in the housing and that it have a vessel wall, which is air and water vapor-permeable, and that at least one heating element be arranged inside the inner vessel.

According to the invention the zeolite in the housing is not in the direct form of a packing, but for its part is rather arranged in at least one additional vessel or inner vessel with air and water vapor-permeable vessel wall. Compared to a conventional packing, this significantly increases the effective surface of the zeolite in relation to the water vapor in the adsorption process and the desorption process, so that both the water vapor absorption capacity of the zeolite and the facilities for expelling the water vapor from the zeolite are improved.

In further development of the invention it is proposed that multiple inner vessels, each with air and water vapor-permeable vessel wall be arranged in the housing. The length of the said inner vessels is as large as possible in relation to their cross sectional dimensions. The inner vessels are cylindrical or rod-shaped, for instance. They may also be polygonal in cross section.

The vessel wall of the inner vessels is preferably composed of a wire mesh, which securely holds together the zeolite packing composed of granulate or globules.

Further features of the invention are set out in the subordinate claims and the description in connection with the drawing.

The invention will be described in more detail below with reference to examples of embodiments represented in the drawing, in which:

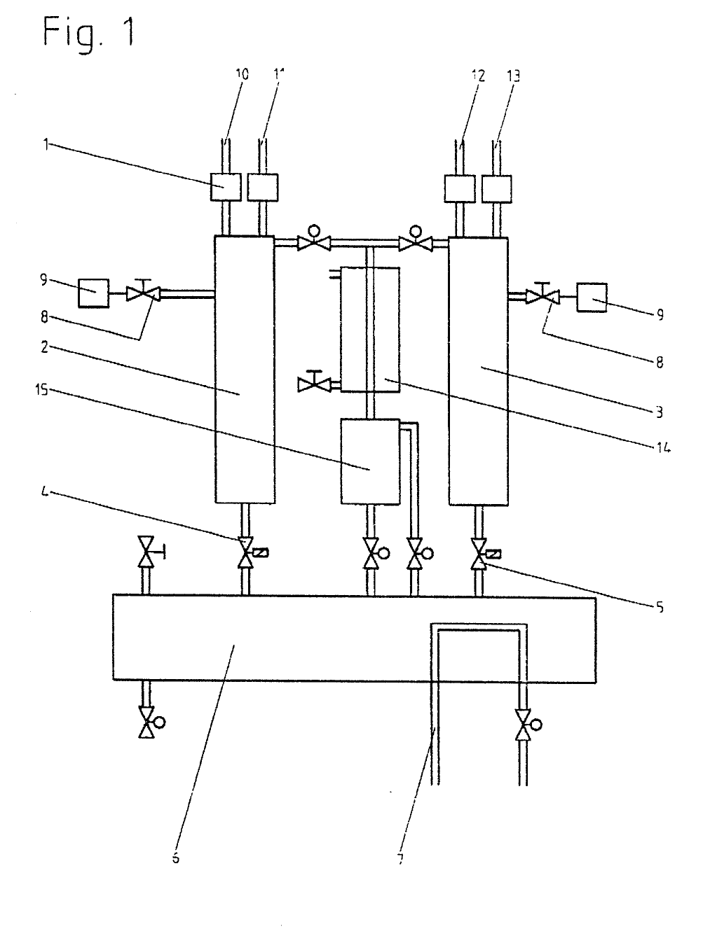

FIG. 1: shows a schematic diagram of a cooling installation;

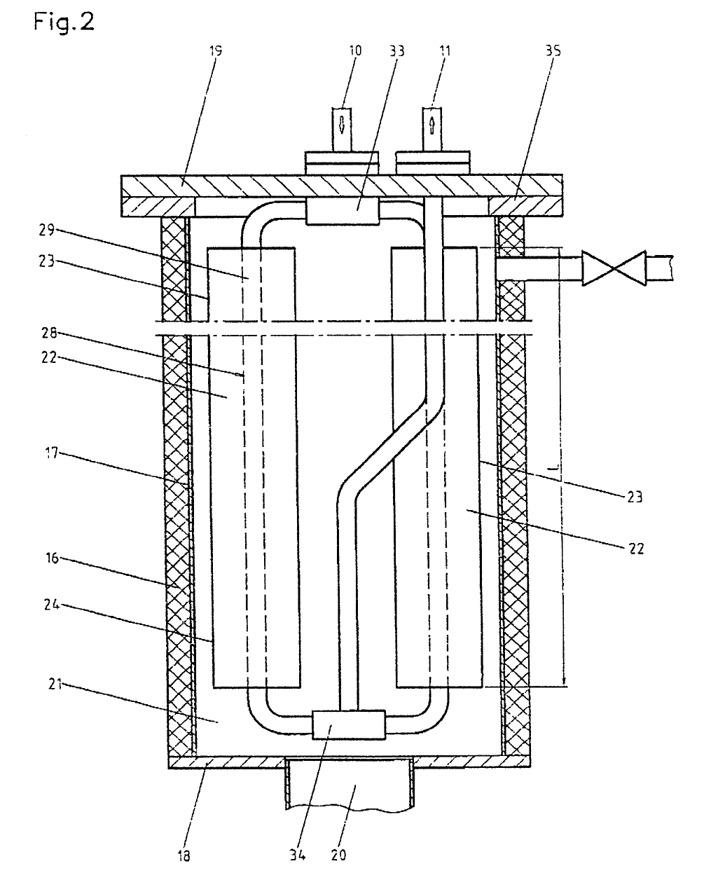

FIG. 2: shows a section through a reactor;

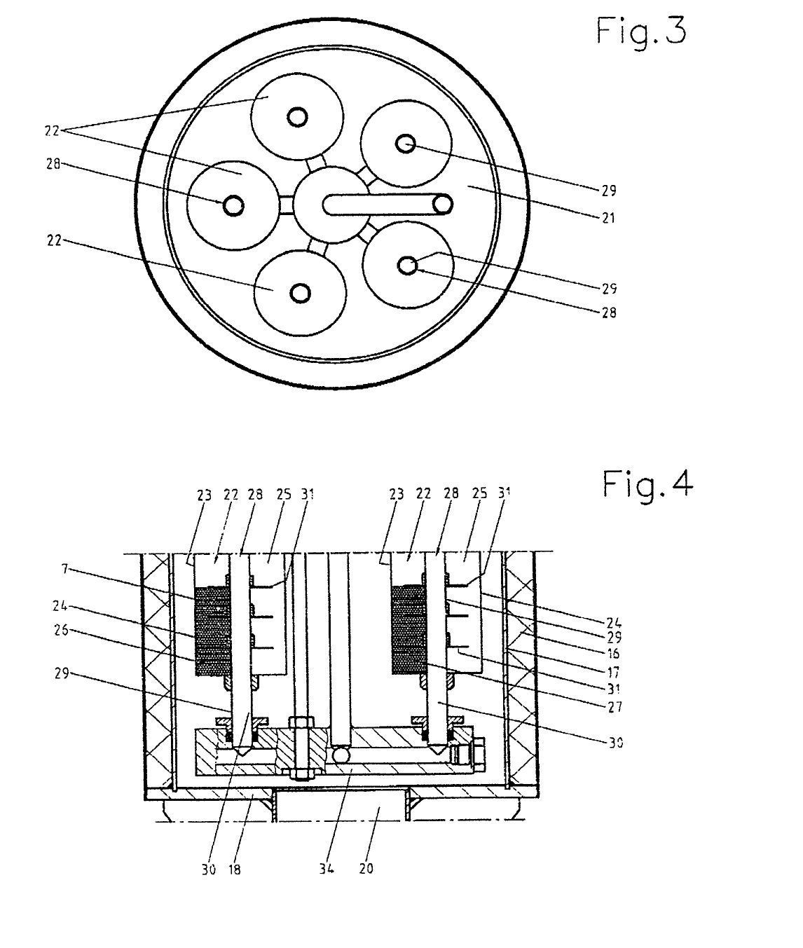

FIG. 3: shows a top view of the reactor after removal of its cover;

FIG. 4: shows a detail of the reactor to a larger scale;

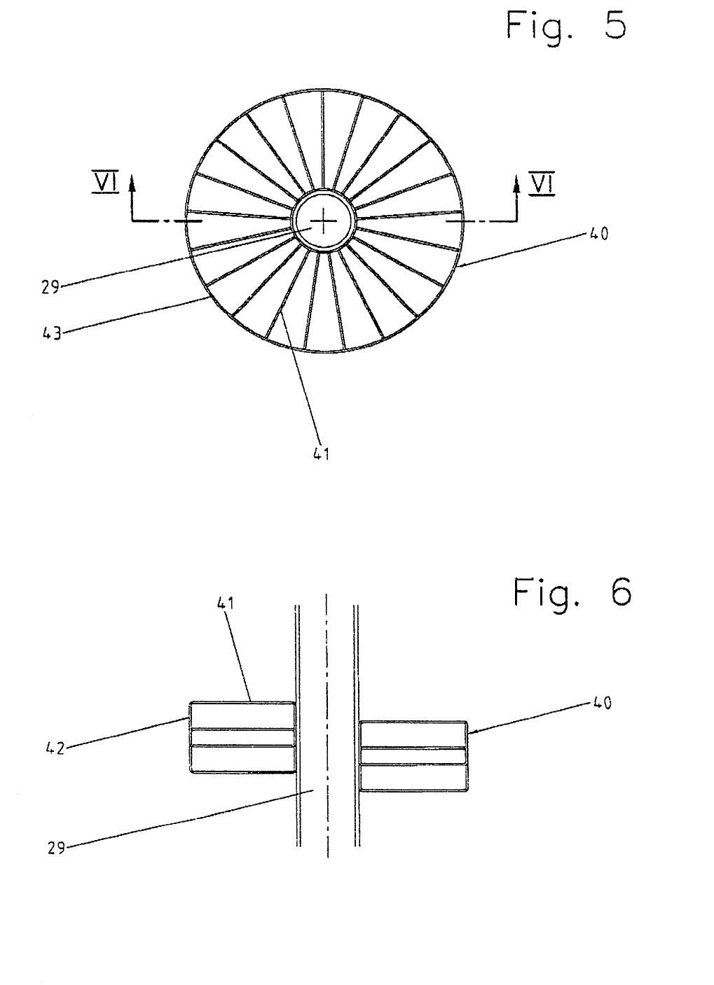

FIG. 5: shows a top view of heat-conducting elements and

FIG. 6: shows a section through some of the heat-conducting elements along the line VI-VI in FIG. 5.

A cooling installation 1 according to FIG. 1 comprises a first reactor 2 serving for the accommodation of zeolite and a second reactor 3, likewise serving for the accommodation of zeolite, which reactors are alternatively connected by way of valves 4 and 5 to a vessel 6 containing a certain quantity of water. The vessel 6 includes parts 7 of a heat exchanger, which makes use of the low temperature generated in the vessel 6.

Both reactors 2 and 3 are further connected by valves 8 to at least one vacuum generator 9. Both reactors 2 and 3 can be supplied with the heat necessary for the desorption process by way of feed and abstraction lines 10 and 11 and 12 and 13 respectively.

The water vapor expelled from the zeolite in the process passes through a sealable outlet opening into a heat exchanger 14, where it condenses and is collected as condensate in a receiver 15, before being returned to the vessel 6.

In contrast to a cooling installation with a single reactor, the cooling installation 1 with two or more reactors permits continuous or virtually continuous operation. Further valves and the like also represented in FIG. 1 are of no further interest in the context of the invention.

The two reactors 2 and 3 are essentially identical in design and according to FIG. 2 comprise a housing 17, provided with an insulation 16, with a base 18 and a cover 19. The base 18 has a suction opening 20 for the water vapor from the vessel 6.

In the example of an embodiment represented in FIGS. 2 and 3, multiple inner vessels 22 containing zeolite are situated in the interior 21 of the housing 17. Each inner vessel 22 has a length L, which is very large in relation to its cross sectional dimensions and may be in the order of 1 to 5 to 1 to 10 or more.

By virtue of its dimensions the inner vessel 22 is rod-shaped. It is preferably cylindrical and may in principle also be polygonal in cross section.

Each inner vessel 22 has a vessel wall 23, which is air and water vapor-permeable. The vessel wall 23 is suitably composed of a wire mesh 24, as shown in FIG. 4.

A lose packing 26 of granulated or globular zeolite 27 is situated in the interior 25 of the inner vessel(s) 22. Heating devices 28 are also arranged in the interior 25 of each inner vessel 22.

The heating device 28 comprises a heating element 29, which suitably extends along the axis 30 of each inner vessel 22. The heating element 29 may be an electrical heating element.

In principle, however, the heating device 28 may also comprise a heating tube corresponding to the heating element 29, which tube serves to carry a hot liquid such as heating oil along the axis 30 of the inner vessel 22.

In order to promote the heat transfer from the heating element 29 or the heating tube to the zeolite 27, heat-conducting elements 31 are arranged in the packing 26 composed of zeolite 27 and are connected to the heating element 29 or the heating tube.

The heat-conducting elements 31 are fin or disk-shaped.

In principle, the heat-conducting elements 31 may also consist of a copper wire mesh, or they comprise a metal network, which surrounds the heating element 29 and is arranged in such a way that the zeolite 27 is to a large extent positively embedded in the metal network.

As FIG. 3 shows, multiple inner vessels 22 are arranged in the housing 17 at intervals from one another. Accordingly, the arrangement of the heating elements 29 or heating tubes for the hot liquid/heating oil is rotationally symmetrical. At the end faces of the housing 17 the heating tubes are each connected to one another by coupling pieces 33 and 34 in the most rotationally symmetrical arrangement possible and are connected to the lines 10 and 11 and 12 and 13 respectively. The lines 10 and 11 and 12 and 13 serve as feed or return line respectively and in each case are connected at an end face 35 of the housing 17 to the heating tubes and/or coupling pieces 33 located in its interior 21.

The two FIGS. 5 and 6 finally show yet another heat-conducting element 40, which surrounds a heating element 29 or a heating tube forming a positive interlock and comprises radially arranged rods 41. According to FIG. 6 the rods 41 are arranged at short intervals one above another and on the outside are connected to one another by means of connecting pieces 42. Further connecting pieces 43 connect each of the rods 41 in one plane, as shown in FIG. 5.

The rods 41 and the connecting pieces 42 and 43 of the heat-conducting element 40 are each composed of a highly thermally conductive material and are therefore capable of abstracting the heat from the heating element 29 outwards to the zeolite located there. The dimensions of the heating conducting element 40 are matched to the dimensions of the interior 25 of the inner vessel(s) 22.

1. A reactor for a cooling installation (1) for performing an adsorption and desorption process, especially with zeolite (27) as adsorbent and with water as adsorbate, the interior (21) of a vacuum-tight housing (17) being connectable to a vacuum generator (9) and to a vessel (6) containing water, and having a heating device (28) and a sealable outlet opening for water vapor, wherein
at least one inner vessel (22) containing the zeolite (27) is provided and has a vessel wall (23), which is permeable to air and water vapor and that
at least one heating device (28) is arranged in the interior (25) of the inner vessel (22).

2. The reactor as claimed in claim 1, wherein
multiple inner vessels (22) each with air and water vapor-permeable vessel wall (23) are arranged in the housing (17).

3. The reactor as claimed in claim 1, wherein
the length (L) of the inner vessel (22) is very large in relation to the dimensions of its cross section.

4. The reactor as claimed in claim 1, wherein
the inner vessel (22) is cylindrical.

5. The reactor as claimed in claim 1, wherein
the inner vessel (22) is rod-shaped.

6. The reactor as claimed in claim 1, wherein
the cross section of the inner vessel (22) is polygonal.

7. The reactor as claimed in claim 1, wherein
the vessel wall (23) is composed of a wire mesh (24).

8. The reactor as claimed in claim 1, wherein
a heating element (29) is provided as heating device (28) and is arranged along the axis (30) of the inner vessel (22).

9. The reactor as claimed in claim 1, wherein
the heating element (29) is an electrical heating element.

10. The reactor as claimed in claim 1, wherein
the heating element (29) is a heating tube for a hot liquid/heating oil and is arranged along the axis (30) of the inner vessel (22).

11. The reactor as claimed in claim 1, wherein
the heat-conducting elements (31), (40) are arranged in the packing (26) composed of zeolite (27) and are connected to the heating device (28).

12. The reactor as claimed in claim 1, wherein
the heat-conducting elements (31) are fin or disk-shaped.

13. The reactor as claimed in claim 1, wherein
the heating conducting element is a copper wire mesh.

14. The reactor as claimed in claim 1, wherein
a metal network is provided as heat-conducting element, which surrounds the heating element (29), and that the zeolite (27) is to a large extent positively embedded in the metal network.

15. The reactor as claimed in claim 1, wherein
the arrangement of the heating elements (29)/heating tubes for the hot liquid/heating oil is rotationally symmetrical.

16. The reactor as claimed in claim 1, wherein
lines (10, 11) and (12, 13) are arranged at one end face (35) of the housing (17) as feed line or return line respectively for hot liquid/heating oil.
